(19) United States
(12) Patent Application Publication
(10) Pub. No.: US 2015/0029039 A1
(43) Pub. Date: Jan. 29, 2015

(54) DRIVING SUPPORT DEVICE

(71) Applicant: Yoshio Mukaiyama, Mishima-shi (JP)

(72) Inventor: Yoshio Mukaiyama, Mishima-shi (JP)

(73) Assignee: TOYOTA JIDOSHA KABUSHIKI KAISHA, Toyota-shi , Aichi-ken (JP)

(21) Appl. No.: 14/377,734

(22) PCT Filed: Feb. 10, 2012
(86) PCT No.: PCT/JP12/53192

§ 371 Date: Aug. 8, 2014

(51) Int. Cl. G08G 1/0967; G08G 1/095

(52) U.S. Cl. CPC G08G 1/096783; G08G 1/095
USPC 340/905

(57) ABSTRACT

A driving support device performs driving support of a vehicle, which is a host vehicle, based on signal cycle information on a lighting cycle of a signal at a service target intersection. When the signal cycle information is not available, the driving support device estimates the signal cycle information based on infrastructure data, which is surrounding information on the intersection, and performs driving support based on the estimated signal cycle information. This allows the driving support device to perform driving support suitably even when the signal cycle information is not available.

### TECHNICAL FIELD

The present invention relates to a driving support device.

### BACKGROUND ART

As a conventional driving support device mounted in a vehicle for supporting a driver to drive a vehicle, a device is known that supports driving based on signal cycle information provided by a traffic light at an intersection. For example, Patent Literature 1 discloses a technology that determines whether a host vehicle is in a dangerous traveling state based on the distance to an intersection, vehicle speed, and signal information provided by a traffic light and, when the vehicle is in a dangerous traveling state, performs acceleration or deceleration control. Similarly, Patent Literatures 2-4 disclose driving support technologies that use signal cycle information.

### CITATION LIST

### Patent Literature

PATENT LITERATURE 1: Japanese Patent Application Publication No. 2008-299666 (JP2008-299666 A)

PATENT LITERATURE 2: Japanese Patent Application Publication No. 2006-048624 (JP2006-048624 A)

PATENT LITERATURE 3: Japanese Patent Application Publication No. 2009-009610 (JP2009-009610 A)

PATENT LITERATURE 4: Japanese Patent Application Publication No. 2009-265837 (JP2009-265837 A)

### SUMMARY OF THE INVENTION

### Technical Problem

However, the conventional technologies described above assume that signal cycle information can be acquired, meaning that there is room for improvement in driving support for use when signal cycle information is not available.

In view of the foregoing, it is an object of the present invention to provide a driving support device capable of suitably supporting driving even when signal cycle information is not available.

### Solution to Problem

To solve the above problems, a driving support device according to the present invention is a driving support device for performing driving support of a host vehicle based on signal cycle information on a lighting cycle of a traffic light at an intersection, the driving support device characterized in that, when the signal cycle information is not available, the device estimates the signal cycle information based on surrounding information on the intersection and performs driving support based on the estimated signal cycle information.

The driving support device described above is preferably characterized in that the device includes a plurality of estimation methods for estimating the signal cycle information and selects an estimation method, used for estimating the signal cycle information, from the plurality of estimation methods according to a scene in which the signal cycle information is not available.

The driving support device described above is preferably characterized in that the device selects a providable service from services for the driving support according to the selected estimation method and the scene.

The driving support device described above is preferably characterized in that a case in which the signal cycle information is not available refers to a case in which a sending side of the signal cycle information fails to send the signal cycle information.

The driving support device described above is preferably characterized in that a case in which the signal cycle information is not available refers to a case in which a receiving side of the signal cycle information fails to receive the signal cycle information.

The driving support device described above is preferably characterized in that a case in which the signal cycle information is not available refers to a case in which an information-processing load in the host vehicle is high and a reception processing of the signal cycle information is delayed.

The driving support device described above is preferably characterized in that the surrounding information includes at least one of road information on the intersection, a presence state of other vehicles or pedestrians around the intersection, a remaining time to a signal type switching time at the intersection, acquired signal cycle information, and a presence state of an emergency vehicle or a public vehicle around the intersection.

The driving support device described above is preferably characterized in that the device determines whether a traveling road of the host vehicle is a major road or a minor road based on road information on the intersection, estimates signal cycle information as equivalent to green light when it is determined that the traveling road is a major road, and estimates signal cycle information as equivalent to red light when it is determined that the traveling road is a minor road.

The driving support device described above is preferably characterized in that the device determines whether the host vehicle is required to stop at the intersection based on a presence state of other vehicles or pedestrians around the intersection, estimates signal cycle information as equivalent to green light when it is determined that the vehicle is not required to stop, and estimates signal cycle information as equivalent to red light when it is determined that the vehicle is required to stop.

The driving support device described above is preferably characterized in that the device estimates signal cycle information based on a remaining time to a signal type switching time at the intersection.

The driving support device described above is preferably characterized in that the device estimates the signal cycle information based on the acquired signal cycle information.

The driving support device described above is preferably characterized in that the device determines whether a traveling road of the host vehicle is a major road or a minor road based on a presence state of an emergency vehicle or a public vehicle around the intersection, estimates signal cycle information as equivalent to green light if it is determined that the traveling road is a major road, and estimates signal cycle information as equivalent to red light if it is determined that the traveling road is a minor road.

### Advantageous Effects of Invention

The driving support device according to the present invention estimates signal cycle information based on surrounding information on an intersection if the signal cycle information is not available. This makes it possible to provide a driving support service, which is based on the signal cycle information, continuously with no interruption, with a resulting effect that allows driving support to be performed suitably even if signal cycle information is not available.

### BRIEF DESCRIPTION OF THE DRAWINGS

FIG. 1 is a block diagram showing a general configuration of a driving support device in one embodiment of the present invention.

FIG. 2 is a schematic diagram showing an example of a configuration of road-vehicle communication carried out by the driving support device in this embodiment.

FIG. 3 is a schematic diagram showing solution 1-1 that is one of the signal cycle information estimation methods performed by the driving support device in this embodiment.

FIG. 4 is a schematic diagram showing solution 1-4 that is one of the signal cycle information estimation methods performed by the driving support device in this embodiment.

FIG. 5 is a schematic diagram showing solution 3-1 that is one of the signal cycle information estimation methods performed by the driving support device in this embodiment.

FIG. 6 is a diagram showing an example of the settings of type of scene in which signal cycle information is not sent, scene determination condition for each scene, selectable solutions, and providable services all of which are used in the signal cycle information estimation processing.

FIG. 7 is a diagram showing an example of the content of situations and means listed in the item “scene determination condition” in FIG. 6.

FIG. 8 is a diagram showing an example of the settings of type of scene in which signal cycle information is not received, scene determination condition for each scene, selectable solutions, and providable services all of which are used in the signal cycle information estimation processing.

FIG. 9 is a diagram showing an example of the content of situations and means listed in the item “scene determination condition” in FIG. 8.

FIG. 10 is a schematic diagram showing a scene in which the “three-color traffic light⇄blink traffic light” scene and the “detection of pushbutton-on/vehicle during blink signal” scene in FIG. 6 are generated.

FIG. 11 is a schematic diagram showing time conditions for solutions that are set for the “three-color traffic light⇄ blink traffic light” scene in FIG. 6.

FIG. 12 is a schematic diagram showing time conditions for solutions that are set for the “three-color traffic light⇄blink traffic light” scene in FIG. 6.

FIG. 13 is a main flow showing the driving support processing performed by the driving support device in this embodiment.

FIG. 14 shows a subroutine showing the processing of solution 1-1 performed by a driving support operation unit.

FIG. 15 shows a subroutine showing the processing of solution 1-2 performed by the driving support operation unit.

FIG. 16 shows a subroutine showing the processing of solution 1-3 performed by the driving support operation unit.

FIG. 17 shows a subroutine showing the processing of solution 1-4 performed by the driving support operation unit.

FIG. 18 shows a subroutine showing the processing of solution 1-5 performed by the driving support operation unit.

FIG. 19 shows a subroutine showing the processing of solutions 3-1 and 3-2 performed by the driving support operation unit.

FIG. 20 is a schematic diagram showing an example of a configuration of road-vehicle communication in a modification of this embodiment.

FIG. 21 is a schematic diagram showing a signal cycle information estimation method in the modification of this embodiment.

FIG. 22 shows a subroutine showing the processing of solution 1-1 in the modification of this embodiment.

### MODES FOR CARRYING OUT THE INVENTION

An embodiment of a driving support device according to the present invention is described below with reference to the drawings. In the drawings below, the same reference numeral is given to the same or corresponding part and the description is not repeated.

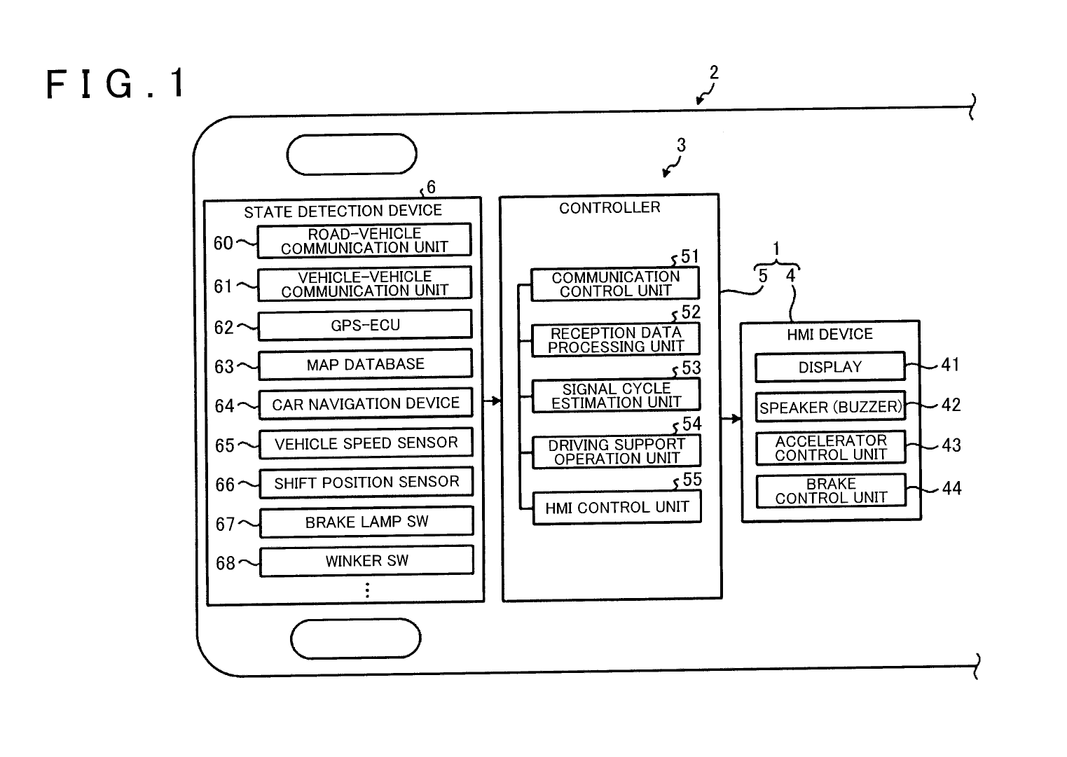

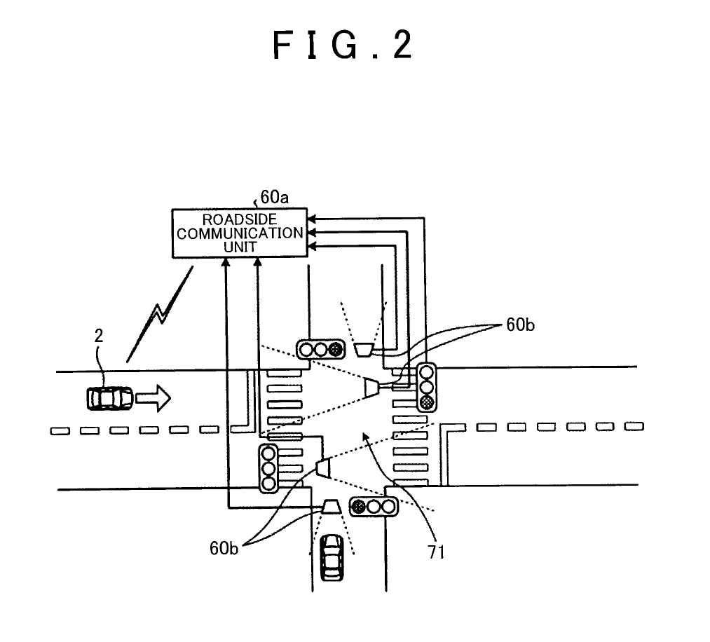

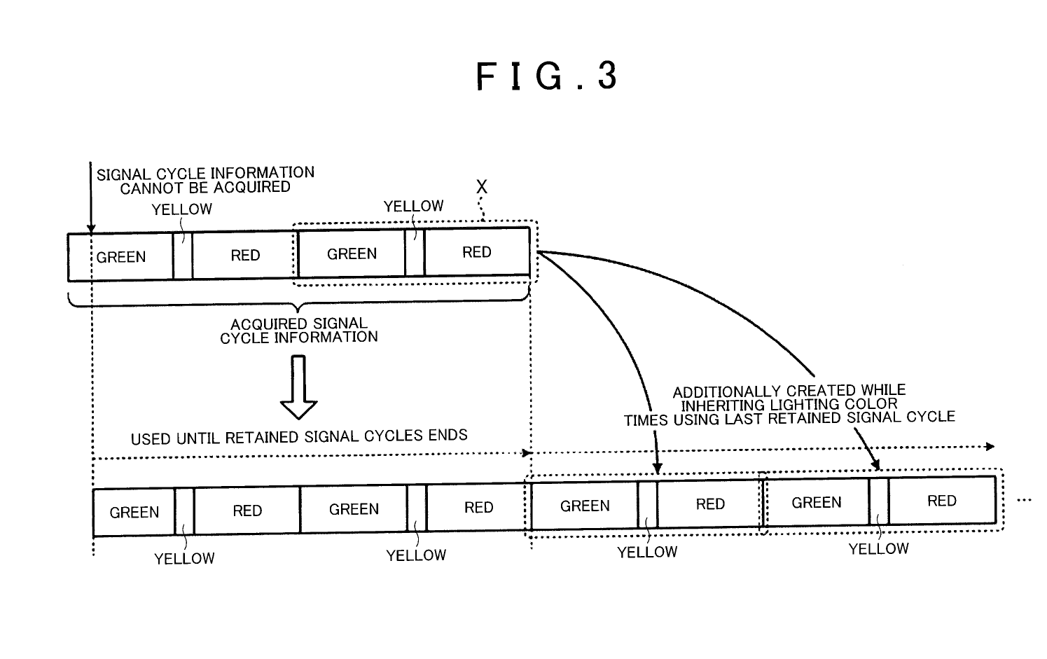

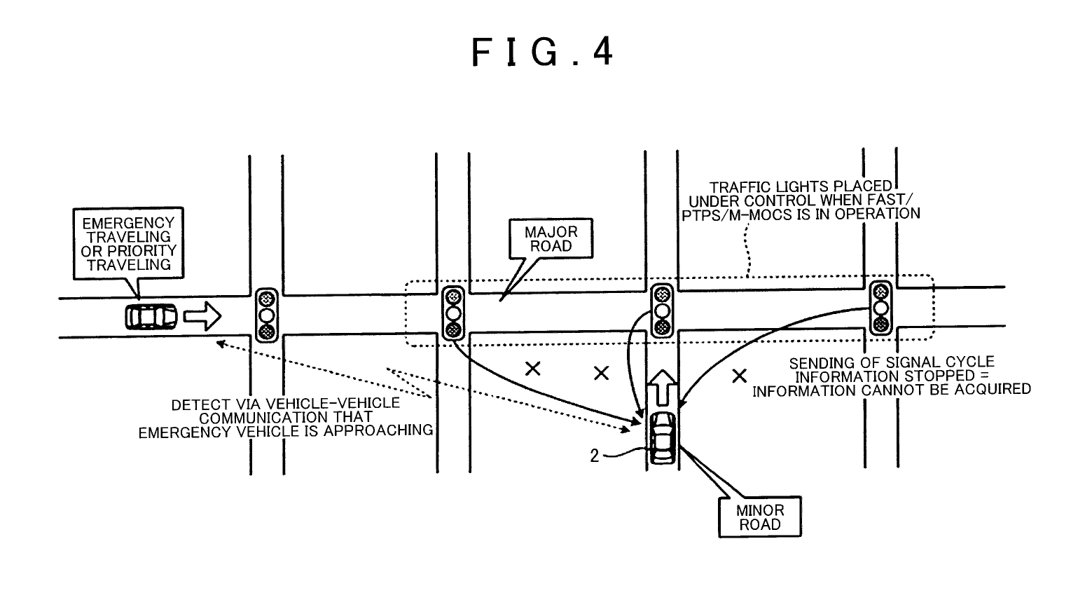

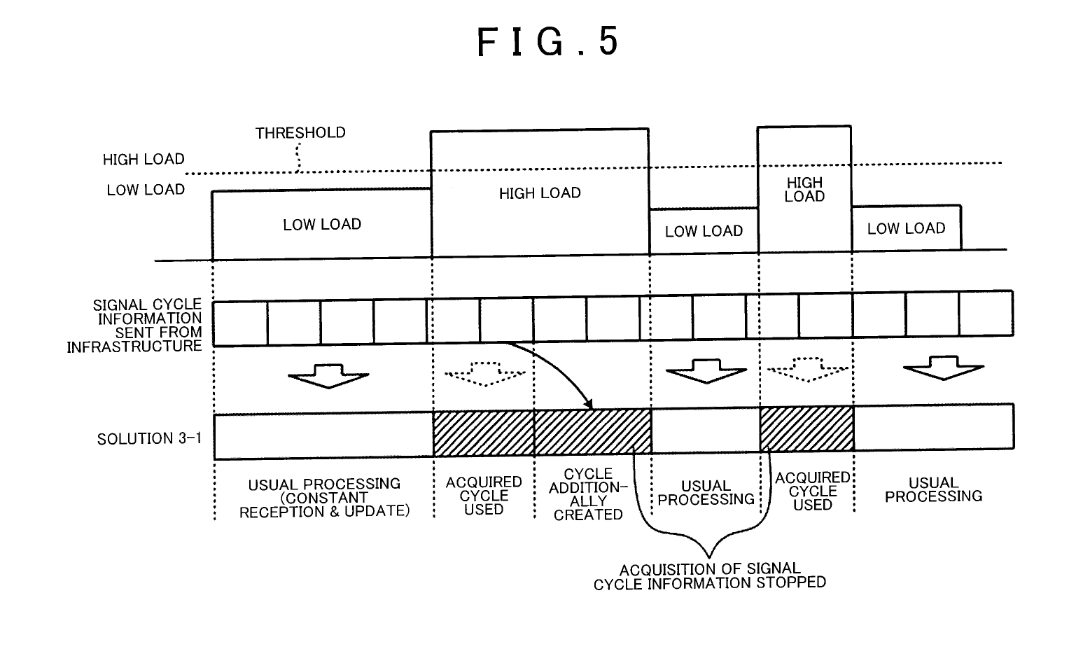

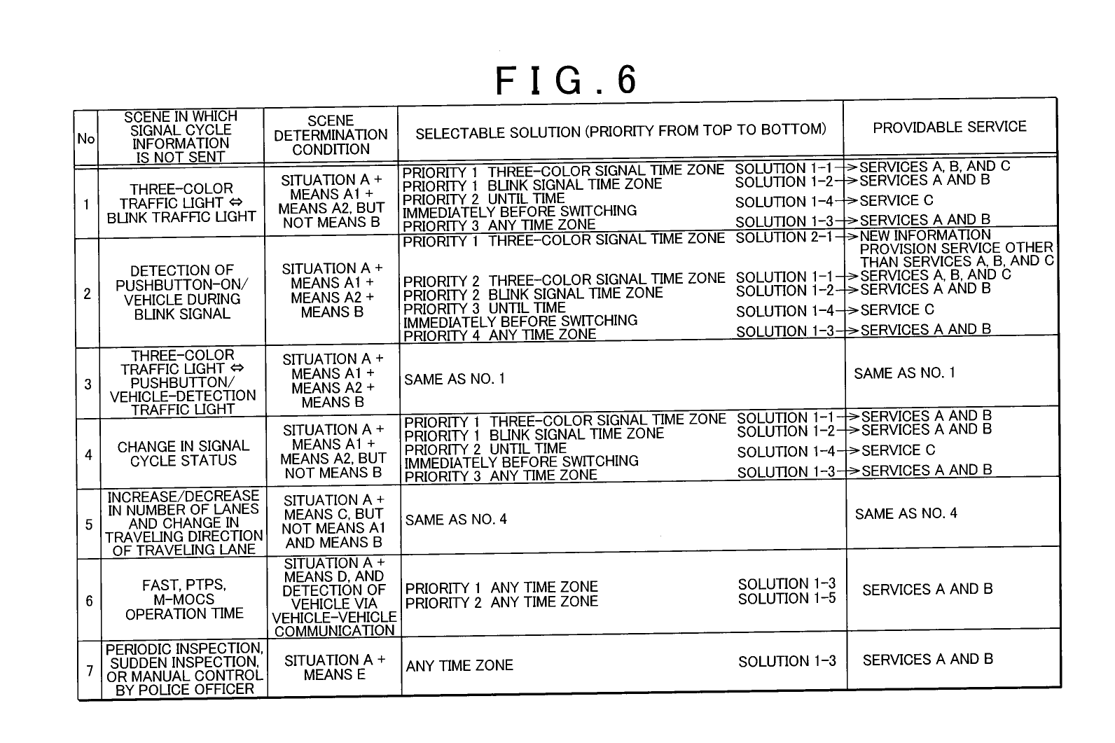

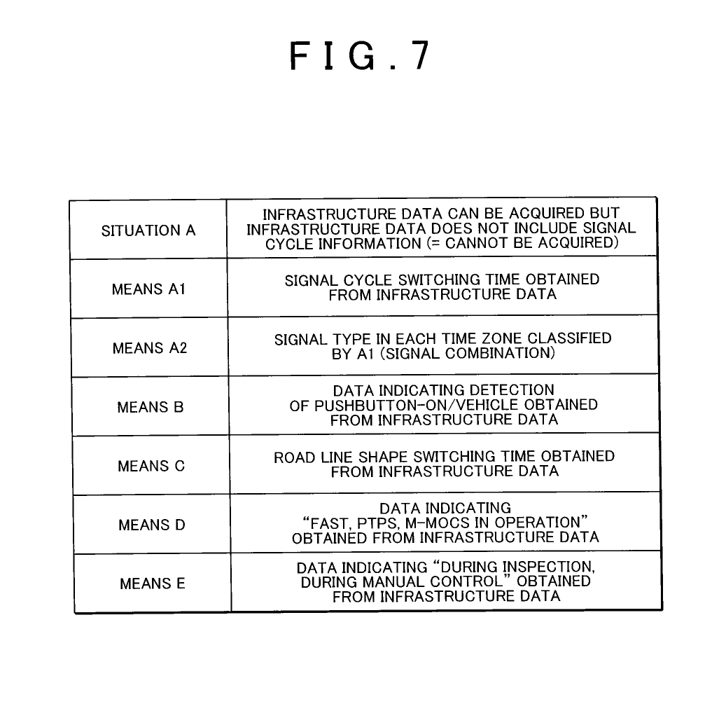

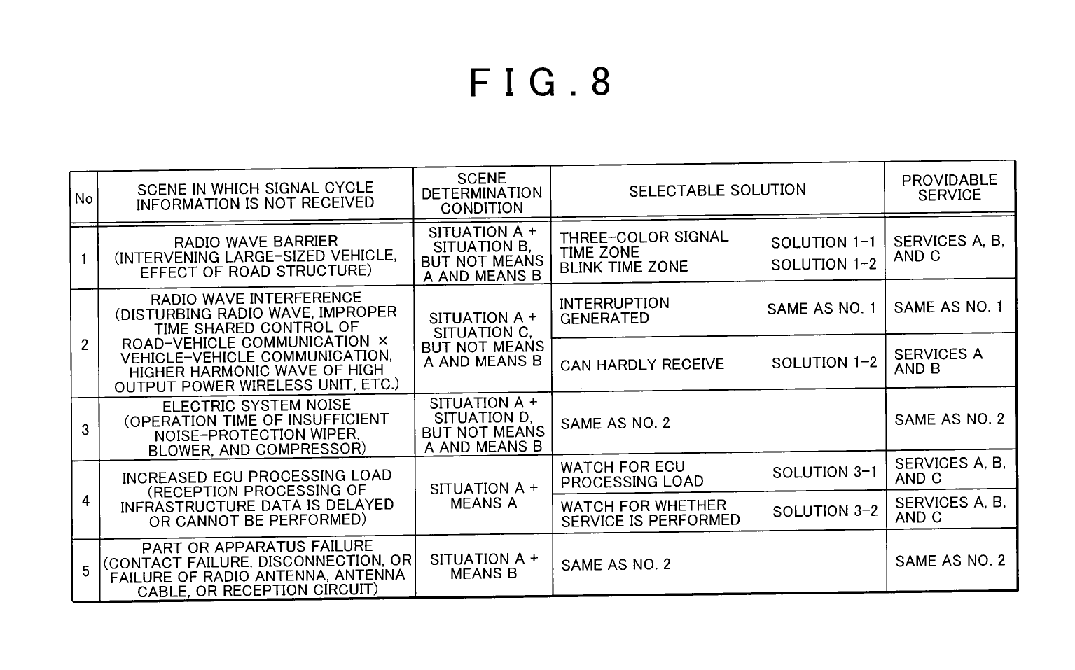

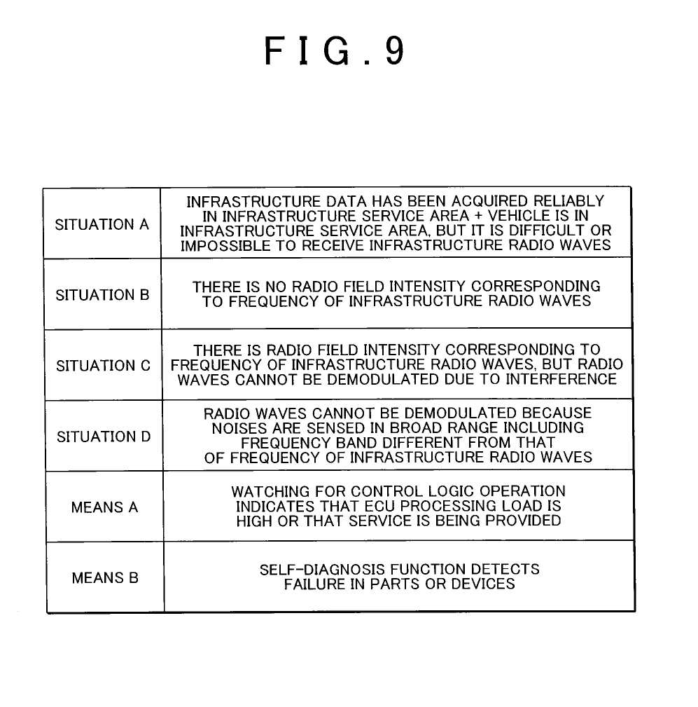

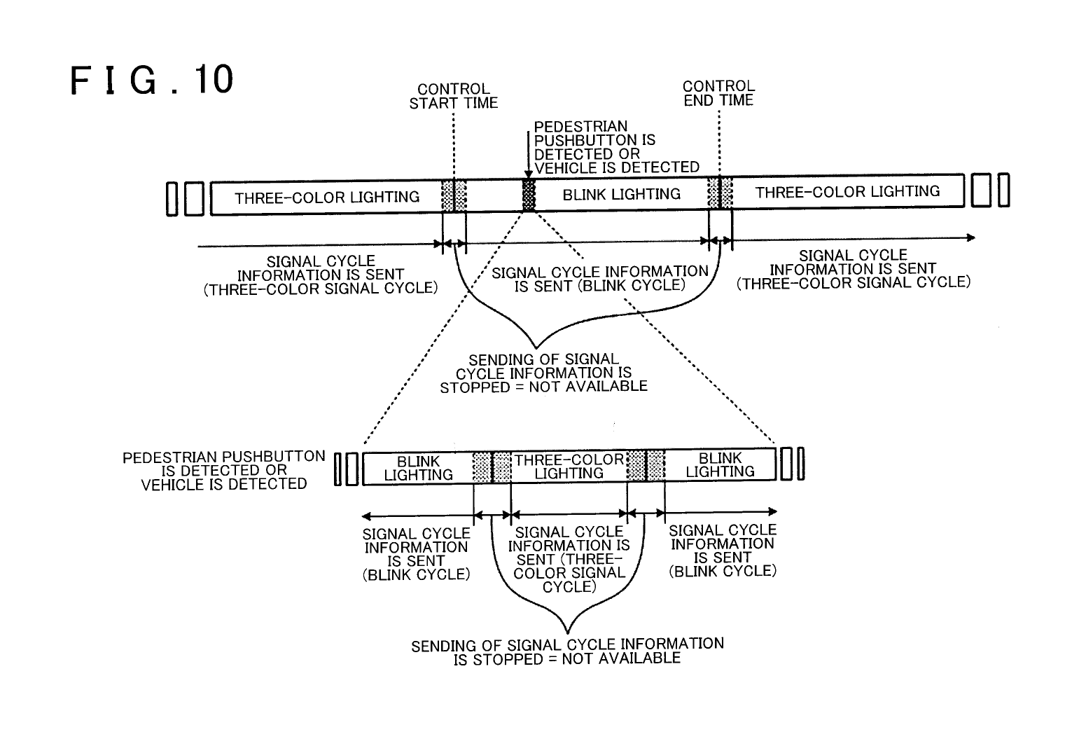

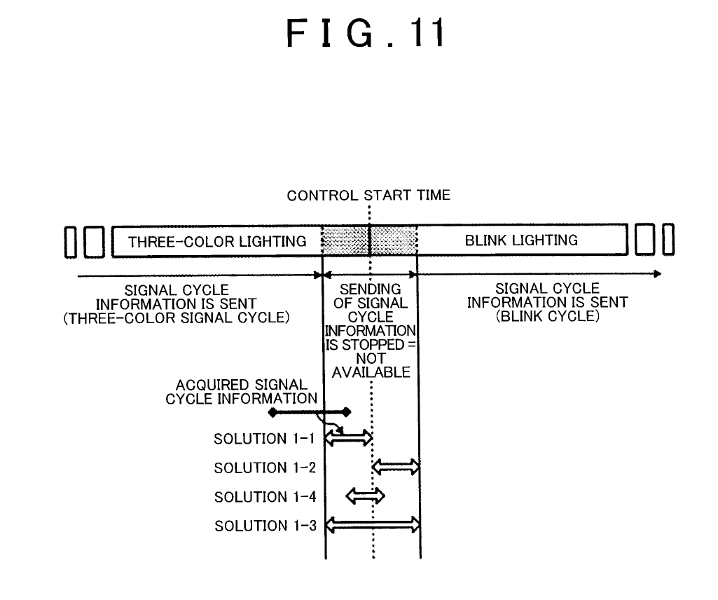

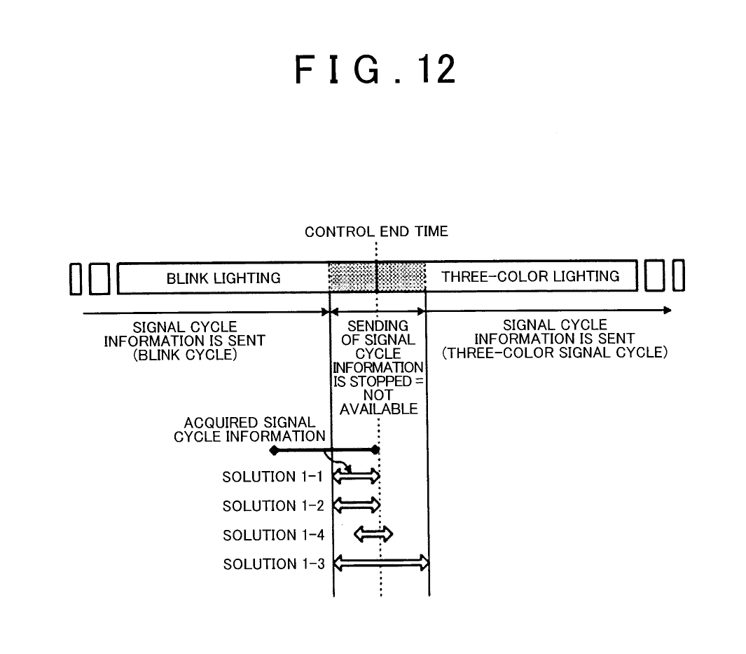

First, the configuration of a driving support device in one embodiment of the present invention is described with reference to FIG. 1 to FIG. 12. FIG. 1 is a block diagram showing a general configuration of a driving support device in one embodiment of the present invention, FIG. 2 is a schematic diagram showing an example of a configuration of road-vehicle communication carried out by the driving support device in this embodiment, FIG. 3 is a schematic diagram showing solution 1-1 that is one of the signal cycle information estimation methods performed by the driving support device in this embodiment, FIG. 4 is a schematic diagram showing solution 1-4 that is one of the signal cycle information estimation methods performed by the driving support device in this embodiment, FIG. 5 is a schematic diagram showing solution 3-1 that is one of the signal cycle information estimation methods performed by the driving support device in this embodiment, FIG. 6 is a diagram showing an example of the settings of type of scene in which signal cycle information is not sent, scene determination condition for each scene, selectable solutions, and providable services all of which are used in the signal cycle information estimation processing, FIG. 7 is a diagram showing an example of the content of situations and means listed in the item “scene determination condition” in FIG. 6, FIG. 8 is a diagram showing an example of the settings of type of scene in which signal cycle information is not received, scene determination condition for each scene, selectable solutions, and providable services all of which are used in the signal cycle information estimation processing, FIG. 9 is a diagram showing an example of the content of situations and means listed in the item “scene determination condition” in FIG. 8, FIG. 10 is a schematic diagram showing a scene in which the “three-color traffic light⇄blink traffic light” scene and the “detection of pushbutton-on/vehicle during blink signal” scene in FIG. 6 are generated, FIG. 11 is a schematic diagram showing time conditions for solutions that are set for the “three-color traffic light⇄link traffic light” scene in FIG. 6, and FIG. 12 is a schematic diagram showing time conditions for solutions that are set for the “three-color traffic light⇄blink traffic light” scene in FIG. 6.

A driving support device 1 in this embodiment is applied to a vehicle control system 3 mounted in a vehicle 2 that is a host vehicle, as shown in FIG. 1. The driving support device 1 includes an HMI (Human Machine Interface) device 4, which works as a support device, and a controller 5 that works as a control device. The driving support device 1, in which the controller 5 controls the HMI device 4 according to the situation to output various types of driving support information (HMI information), supports a driver to drive the vehicle 2 safely.

The vehicle 2 has one of an engine and a motor as the traveling power source for driving the driving wheels. The vehicle 2 may be any one of a hybrid (HV) vehicle that has both an engine and a motor, a conventional vehicle that has an engine but not a motor, and an EV vehicle that has a motor but not an engine.

The vehicle control system 3 in this embodiment is the so-called radio-wave-medium based infrastructure cooperative system that supports driving by communicating with roadside units installed on the road side. The vehicle control system 3 acquires various types of information, such as signal information, oncoming vehicle information, and pedestrian information, from roadside units. The vehicle control system 3 allows the driving support device 1 to provide driving support information to a driver based on these various types of information. In this way, the driving support device 1 provides guidance support for the driving operation performed by a driver.

The driving support device 1 in this embodiment provides the driving support service when the vehicle 2 approaches a service target intersection, using the signal cycle information on lighting-color cycles of a traffic light at an intersection where driving support service is provided (hereinafter also referred to as a service target intersection, a target intersection, or simply an intersection). More specifically, the following services are provided: “traffic light service” (also referred to as service A) that is a safety service for alerting a driver to a condition in which the driver overlooks no-entry lighting colors such as red light or blinking red light, “accelerator-off support or green wave” (also referred to as service B) that is an eco-service for prompting a driver to accelerate or decelerate a vehicle for reducing wasteful fuel consumption or for improving HV (hybrid) regeneration efficiency, and “transmission notification service” (also referred to as service C) that is an eco-service for providing information indicating a time to the end of the red light to enable a driver to quickly start a vehicle.

More specifically, the vehicle control system 3 is configured by including the HMI device 4, the controller 5, and a state detection device 6. The HMI device 4 and the controller 5 configure the driving support device 1.

The HMI device 4 performs driving support for supporting the driving of the vehicle 2. The HMI device 4 can output driving support information that is information for supporting the driving of the vehicle 2. The HMI device 4 performs driving support by providing driving support information to a driver. The HMI device 4 is an in-vehicle device. The HMI device 4 is configured by including a display 41 and a speaker (or a buzzer) 42 provided in the vehicle interior of the vehicle 2. The display 41 is a visual information display device that outputs visual information (graphic information, character information). The speaker 42 is an auditory information (voice) output device that outputs auditory information (voice information, sound information). The HMI device 4 outputs visual information and auditory information, thus providing guidance for the driving operation performed by a driver. The HMI device 4 provides the information as described above to support a driver to perform the driving operation.

The HMI device 4 includes an accelerator control unit 43 that automatically controls the accelerator opening degree of the vehicle 2 and a brake control unit 44 that automatically controls the brake amount of the vehicle 2. The HMI device 4 directly controls the acceleration and deceleration of the vehicle 2 by means of the accelerator control unit 43 and the brake control unit 44 to support the driver to perform the driving operation. The HMI device 4, electrically connected to the controller 5, is controlled by the controller 5.

The controller 5 is a control unit that integrally controls the whole vehicle control system 3 including the HMI device 4. The controller 5 is configured as an electronic circuit with a known microcomputer as its main component wherein the microcomputer includes a CPU, a ROM, a RAM, and an interface. The controller 5 is used also as an ECU (Electronic Control Unit) that controls the components of the vehicle 2.

The state detection device 6, a device for detecting the state of the vehicle 2 and the state around the vehicle 2, detects the various state amounts or physical amounts, which indicate the state of the vehicle 2, and the operation state of the switches. The state detection device 6, electrically connected to the controller 5, outputs various signals to the controller 5. The state detection device 6 is configured by including a road-vehicle communication unit 60, a vehicle-vehicle communication unit 61, a GPS (Global Positioning System)-ECU 62, a map database 63, a car navigation device 64, a vehicle speed sensor 65, a shift position sensor 66, a brake lamp switch (SW) 67, a winker switch (SW) 68, and so on.

As exemplified in FIG. 2, the road-vehicle communication unit 60 is a device that works with the infrastructure, such as roadside communication units 60a installed at a service target intersection 71, to acquire various types of infrastructure data.

The service target intersection 71, where driving support is performed by the driving support device 1, is provided with the roadside communication units 60a and detection sensors 60b. The detection sensor 60b, such as a radar (millimeter wave radar), is provided in a lane that is on a road forming the service target intersection 71 and that enters the intersection 71. Upon detecting the vehicle 2 traveling toward the intersection, the detection sensor 60b sends data to the roadside communication unit 60a as vehicle detection sensor data. In addition, upon detecting a pedestrian crossing the intersection 71, the detection sensor 60b sends information to the roadside communication unit 60a as the pedestrian information. Although, in the schematic diagram in FIG. 2, one detection sensor 60b is illustrated in each road entering the intersection for the sake of description, a plurality of detection sensors 60b are provided according to the number of lanes and the number of pedestrian crossings.

In addition to the vehicle detection sensor data and the pedestrian information detected by the detection sensor 60b described above, the roadside communication unit 60a can further acquire various types of dynamic infrastructure data on the surrounding of the vehicle 2 and the service target intersection 71. The dynamic infrastructure data includes the signal cycle information on the traffic lights in the intersection 71, control signal information for switching the signal types of the traffic lights (including control start time, control end time, signal cycle switching time, signal type before and after switching, pedestrian pushbutton ON detection information, and vehicle detection information), and road information.

The roadside communication unit 60a is a communication unit that can wirelessly send and receive data to and from the road-vehicle communication units 60 (the so-called road-vehicle communication). The road-vehicle communication unit 60 and the roadside communication unit 60a in this embodiment acquire various types of information via broadband, wireless communication that uses a radio wave communication medium capable of communication in a range wider than that of narrowband communication used by an optical beacon and DSRC (Dedicated Short Range Communication). The road-vehicle communication unit 60 and the roadside communication unit 60a can communicate with each other at all times not only when the vehicle 2 is in an intersection but also when the vehicle 2 is several hundred meters away from an intersection, meaning that various types of information can be transferred also when the vehicle 2 is approaching an intersection. The road-vehicle communication unit 60, electrically connected to the controller 5, outputs signals on infrastructure data to the controller 5.

Returning to FIG. 1, the vehicle-vehicle communication unit 61 is a device that cooperates with a vehicle-vehicle communication unit, mounted in other vehicles, to acquire various types of information on the other vehicles. Just as with the road-vehicle communication unit 60, the vehicle-vehicle communication unit 61 sends and receives various types of information to and from other vehicles via broadband, wireless communication that uses a radio wave communication medium capable of communication in a wider range. The information on other vehicles acquired by the vehicle-vehicle communication unit 61 includes at least one of information on surrounding vehicles, information on emergency-vehicle/public-vehicle identification, and information on surrounding passers-by. The vehicle-vehicle communication unit 61, electrically connected to the controller 5, outputs signals on other vehicle information to the controller 5.

The GPS-ECU 62 is a device that detects the current position of the vehicle 2. The GPS-ECU 62 receives the GPS signal that is delivered by the GPS satellites to indicate the position information and the traveling direction information (GPS information) on the vehicle 2. The GPS-ECU 62, electrically connected to the controller 5, outputs the received GPS signal to the controller 5.

The map database 63 stores static infrastructure information such as map information that includes road information. For example, the road information includes at least one of road slope information, road-surface state information, road shape information, vehicle speed limit information, and road curvature (curve) information. The road information stored in the map database 63 includes road line-shape information on the width of a road or the number of lanes and the information on whether there is a stop line or a pedestrian crossing. The information stored in the map database 63 is referenced as necessary by the controller 5 to read necessary information.

The car navigation device 64 is a device that guides the vehicle 2 to a predetermined destination. From the information stored in an internal map information database, the information on the current position acquired by the GPS communication unit, and the information on a destination entered by a driver, the car navigation device 64 detects a route to the destination and displays the detected route information on the display unit. The information stored in the car navigation device 64 may include the road information similar to that stored in the map database 63. This information is referenced as necessary by the controller 5 to read necessary information.

The vehicle speed sensor 65 detects the vehicle travel speed (hereinafter sometimes called “vehicle speed”) of the vehicle 2 as the vehicle information. The shift position sensor 66 detects the shift position of the vehicle 2, selected by the driver, as the vehicle information. The brake lamp SW 67 detects whether the driver depresses the brake pedal (brake operation) on the vehicle 2 as the vehicle information. The winker SW 68 detects whether the driver switches winker on (direction indicator) (winker operation) on the vehicle 2 as the vehicle information.

The controller 5 described above receives the infrastructure data, other-vehicle information, position (GPS) information, and vehicle information all of which are detected and acquired by the state detection device 6, various types of information stored in the map database 63, and electric signals corresponding to the driving signals and the control commands of the components. The controller 5 controls the components of the vehicle control system 3, including the HMI device 4, in response to the received electric signals.

The driving support device 1, in which the controller 5 controls the HMI device 4 to perform driving support according to the situation, supports a driver by prompting him or her to perform a predetermined driving operation. The driving support device 1, in which the HMI device 4 outputs various types of driving support information under control of the controller 5 to perform driving support, gives guidance and support to a driver to prompt him or her to perform a recommended driving operation.

More specifically, the controller 5 functionally and conceptually includes a communication control unit 51, a reception data processing unit 52, a signal cycle estimation unit 53, a driving support operation unit 54, and an HMI control unit 55, as shown in FIG. 1.

The communication control unit 51 controls the road-vehicle communication unit 60 and the vehicle-vehicle communication unit 61. When the vehicle 2 enters a support target area and a driving support start instruction is issued, the communication control unit 51 starts communication via the road-vehicle communication unit 60 and the vehicle-vehicle communication unit 61.

The reception data processing unit 52 performs signal processing for data received via the road-vehicle communication unit 60 and the vehicle-vehicle communication unit 61. The received data signal has been processed by various signal processing such as the compression processing and the encryption processing. The reception data processing unit 52 restores the data signal, for which the various processing has been performed, and converts the data signal to a format the controller 5 can use for various operation processing.

When infrastructure data, received via the road-vehicle communication unit 60, does not include signal cycle information on the service target intersection 71 for some reason or other, the signal cycle estimation unit 53 estimates signal cycle information based on the surrounding information on the intersection 71. The detailed function of the signal cycle estimation unit 53 will be described later with reference to FIGS. 3 to 12.

The “surrounding information on an intersection” used in this embodiment refers specifically to infrastructure data not including signal cycle information. For example, as will be described later, the surrounding information on an intersection includes road information on the intersection 71, whether or not other vehicles or pedestrians are present around the intersection 71, the remaining time to the signal type switching time at the intersection 71, acquired signal cycle information, and whether or not emergency vehicles or public vehicles are present around the intersection 71. The “infrastructure data” used in this embodiment refers to information that can be acquired by cooperating with the infrastructure around the vehicle. The infrastructure data includes the information acquired not only by the road-vehicle communication unit 60 and the vehicle-vehicle communication unit 61 but also by various devices such as the GPS-ECU 62, map database 63, and car navigation device 64.

The driving support operation unit 54 performs operation on driving support. For example, the driving support operation unit 54 performs various operations on above-described driving support services A, B and C, based on the infrastructure data around, and the signal cycle information on, the service target intersection 71. In addition, when the signal cycle information on the service target intersection 71 is not available, the driving support operation unit 54 performs operation on the driving support service using the signal cycle information estimated by the signal cycle estimation unit 53.

The HMI control unit 55 controls the HMI device 4 based on the operation result produced by the driving support operation unit 54. The HMI control unit 55 controls the HMI device 4 to cause it to output driving support information, thus presenting driving support information to a driver.

The function of the signal cycle estimation unit 53 in this embodiment is described below in detail with reference to FIGS. 3-12. When signal cycle information is not available, the signal cycle estimation unit 53 estimates the signal cycle information using other information included in the infrastructure data.

The signal cycle estimation unit 53 has a plurality of solutions (estimation methods) for estimating the signal cycle information. The solutions are classified into eight, 1-1, 1-2, 1-3, 1-4, 1-5, 2, 3-1, and 3-2, according to the information used in the estimation. The signal cycle estimation unit 53 estimates signal cycle information using these plurality of solutions according to the various scenes in which the signal cycle information is not available. The following describes each of the solutions.

(Solution 1-1)

In solution 1-1, the signal cycle estimation unit 53 estimates signal cycle information based on the acquired signal cycle information. Referring to FIG. 3, the data of the signal cycle information is usually retained for another several cycles. In the example shown in FIG. 3, at the time the signal cycle information is not available, the signal cycle information is retained for about another two cycles.

In solution 1-1, the acquired signal cycle information is used until the retained signal cycle ends. After that, new signal cycle information is created because no signal cycle information is retained. The signal cycle information is updated by additionally creating signal cycle information, using the last cycle X of the acquired signal cycle information, while inheriting the lighting color times thereafter.

(Solution 1-2)

In solution 1-2, the signal cycle estimation unit 53 estimates signal cycle information based on the road information (road line-shape information, map information). More specifically, the signal cycle estimation unit 53 determines the major/minor relation of the roads, which enter the service target intersection 71, using the road line-shape information acquired by the road-vehicle communication unit 60 or the map information (or road information) acquired by the car navigation device 64. Then, the signal cycle estimation unit 53 determines whether the road on which the vehicle 2, the host vehicle, is traveling is a major road or a minor road.

After that, the signal cycle estimation unit 53 estimates signal cycle information according to the determination result of the major/minor relation of the traveling road. More specifically, if the road on which the host vehicle is traveling is a major road, the signal cycle information is updated with the blinking yellow light (equivalent to green light) or the continuous green light. If the road is a minor road, the signal cycle information is updated with the blinking red light (equivalent to red light) or the continuous red light.

(Solution 1-3)

In solution 1-3, the signal cycle estimation unit 53 estimates signal cycle information based on whether other vehicles are present around the intersection. More specifically, the signal cycle estimation unit 53 acquires vehicle detection sensor data, collected by the detection sensors 60b at the service target intersection 71, from the road-vehicle communication unit 60, estimates the state of surrounding vehicles on both the road, on which the host vehicle is traveling, and the road perpendicular to that road based on the vehicle detection sensor data, and determines the stop requirement (passage permission) of the vehicle 2 at the intersection 71.

After that, the signal cycle estimation unit 53 estimates the signal cycle information according to the stop requirement of the vehicle 2 at the service target intersection 71. More specifically, if it is determined that the vehicle 2 is not required to stop, the signal cycle information is updated to information equivalent to green light. If it is determined that the vehicle 2 is required to stop, the signal cycle information is updated to information equivalent to red light.

(Solution 1-4)

In solution 1-4, the signal cycle estimation unit 53 estimates signal cycle information based on the signal type switching time. The signal type includes the signal lighting method (method such as three-color, blink, pushbutton, vehicle detection) and the signal cycle status (lighting color display sequence, combination of display content).

More specifically, in solution 1-4, the signal cycle estimation unit 53 acquires the signal cycle switching time (switching time of the signal lighting method or the signal cycle status) from the infrastructure data and calculates the remaining time to the signal type switching. After that, according to the calculated remaining time, the signal cycle estimation unit 53 estimates the signal cycle information with the period to the signal cycle switching time as equivalent to red light. In addition, when the vehicle 2 is in the stopped state at a stop line in the intersection 71, the signal cycle estimation unit 53 can count down the remaining time (remaining number of seconds) to the signal type switching to perform the start notification service (service C).

(Solution 1-5)

In solution 1-5, the signal cycle estimation unit 53 estimates signal cycle information based on whether an emergency vehicle or a public vehicle is present around the intersection.

When the existing FAST (Fast Emergency Vehicle Preemption System), PTPS (Public Transportation Priority System), or M-MOCS (Mobile Operation Control System) is in operation, the traffic lights are controlled so that green light is preferentially displayed on the traffic lights on a road on which an emergency vehicle, such as an ambulance or a fire engine, or a public vehicle, such as a bus, travel. At this time, the sending of signal cycle information from the traffic lights, which are under control of FAST/PTPS/M-MOCS at its operation time, is stopped as shown in FIG. 4.

With this in mind, the signal cycle estimation unit 53 estimates the signal cycle information in solution 1-5 as follows. That is, the emergency vehicle flag or the public vehicle flag on other surrounding vehicles is acquired from the vehicle-vehicle communication data. If it is detected, via the vehicle-vehicle communication unit 61, that an emergency vehicle or a public vehicle is approaching, the road on which the emergency vehicle or public vehicle is traveling is determined as a major road in the intersection 71 with the intersecting road as a minor road. If the road on which the host vehicle is traveling is a major road, the signal cycle information is updated to information equivalent to green light; if the road on which the host vehicle is traveling is a minor road, the signal cycle information is updated to information equivalent to red light. In the example shown in FIG. 4, because the road on which the vehicle 2 is traveling intersects with the road on which an emergency vehicle is traveling, the road is determined as a minor road with the signal cycle information updated to information equivalent to red light.

(Solution 2)

In solution 2, the signal cycle estimation unit 53 estimates signal cycle signal supposing that either pedestrians or other vehicles are present around an intersection in response to the detection that the pedestrian pushbutton is turned ON or vehicles are present in the intersection. For example, in solution 2, the signal cycle information may be updated to information equivalent to blinking yellow light for all roads entering the intersection.

In addition, in solution 2, the information indicating that “there are pedestrians waiting to cross the intersection” or “there are vehicles waiting to enter the intersection” can be presented to a driver. By providing such information, a new service other than services A, B, and C can be supplied to alert a driver to pedestrians or vehicles that may enter the intersection without waiting for the signal to change.

(Solution 3-1)

In solution 3-1, the signal cycle estimation unit 53 estimates signal cycle information according to a processing load on the ECU of the vehicle 2.

As shown in FIG. 5, the ECU is in a low-load state in which the ECU processing load is lower than a predetermined threshold or in a high-load state in which the ECU processing load is higher than the predetermined threshold. When the ECU is in a high-load state, the reception of infrastructure data is delayed and, as a result, the acquisition of signal cycle information is delayed in some cases. To solve this problem, the following is performed in solution 3-1. That is, when the ECU processing load becomes high, the acquisition processing of signal cycle information is stopped as shown by the shaded area in FIG. 5 to reduce the processing load with priority on service provision. At this time, as shown in FIG. 5, the signal cycle information is additionally created using the acquired signal cycle information, as in solution 1-1, to update the signal cycle information.

(Solution 3-2)

In solution 3-2, the signal cycle estimation unit 53 estimates signal cycle information according to whether the driving support service is provided. More specifically, before the service is started, the signal cycle information reception processing is performed as usual. From the start to the end of the service (during which the service is provided), the acquisition processing of signal cycle information is stopped to reduce the processing load with priority on service provision. At this time, the signal cycle information is additionally created using the acquired signal cycle information, as in solution 1-1, to update the signal cycle information.

The signal cycle estimation unit 53 can select one of the plurality of solutions according to various signal cycle information non-acquisition scenes (situations) for estimating signal cycle information. The signal cycle information non-acquisition scenes are divided roughly into two: a scene in which the signal cycle information sending side (infrastructure) does not send the information and a scene in which the sending side sends signal cycle information but the receiving side (vehicle 2) does not receive the information.

Now, referring to FIGS. 6 and 8, the following describes in detail the signal cycle information non-acquisition scenes that are assumed in this embodiment. FIG. 6 is a diagram showing an example of the settings of the scene determination condition, selectable solution, and providable service for each of the signal cycle information non-acquisition scenes which are assumed in this embodiment and in which signal cycle information is not sent.

As shown in FIG. 6, the following seven types of scene are set as a scene in which signal cycle information is not sent: “three-color traffic light⇄blink traffic light”, “detection of pushbutton-ON/vehicle during blink signal”, “three-color traffic light pushbutton/vehicle-detection traffic light”, “change in signal cycle status”, “increase/decrease in number of lanes and change in traveling direction of driving lane”, “FAST, PTPS, M-MOCS operation time”, and “periodic inspection, sudden inspection, or manual control by police officer”.

(Three-Color Traffic Light⇄Blink Traffic Light)

The “three-color traffic light⇄blink traffic light” scene refers to a scene in which the signal lighting method of a traffic light is changed between the three-color method and the blink method as shown in the top of FIG. 10. At this change time and in a predetermined time zone several minutes before and after the change time, the signal cycle information is not sent from the roadside transmitter or the signal cycle information that is sent is filled with invalid values. The control start time at which the lighting method is changed from the three-color method to the blink method and the control end time at which the lighting method is returned from the blink method to the three-color method can be acquired from the infrastructure data. The driving support device can determine the predetermined several minutes before and after each of the predetermined times as a time zone during which the sending of signal cycle information is stopped.

(Detection of Pushbutton-ON/Vehicle During Blink Signal)

The “detection of pushbutton-ON/vehicle during blink signal” scene refers to a scene in which the blink traffic light changes its lighting method to three-color lighting in response to the detection that the pedestrian pushbutton is turned ON or a vehicle is present, as shown in the bottom of FIG. 10. At this change time and in a predetermined time zone several minutes before and after the change time, the signal cycle information is not sent from the roadside transmitter or the signal cycle information that is sent is filled with invalid values. The driving support device can acquire, from the infrastructure data, the information on whether the pedestrian pushbutton is turned ON is detected or whether a vehicle is detected.

(Three-Color Traffic Light⇄Pushbutton/Vehicle-Detection Traffic Light)

The “three-color traffic light⇄pushbutton/vehicle-detection traffic light” scene refers to a scene in which the signal lighting method of a traffic light is changed between the three-color method and the pushbutton/vehicle-detection method. At this change time and in a predetermined time zone several minutes before and after the change time, the signal cycle information is not sent from the roadside transmitter or the signal cycle information that is sent is filled with invalid values. The control start time at which the lighting method is changed from the three-color method to the pushbutton/vehicle-detection method and the control end time at which the lighting method is returned from the pushbutton/vehicle-detection method to the three-color method can be acquired from the infrastructure data. The driving support device can determine the several minutes before and after the predetermined times as a time zone during which the sending of signal cycle information is stopped.

(Change in Signal Cycle Status)

The “change in signal cycle status” scene refers to a scene in which the signal cycle status (lighting color display sequence, combination of display content, etc.) of a traffic light is switched. At this change time and in a predetermined time zone several minutes before and after the change time, the signal cycle information is not sent from the roadside transmitter or the signal cycle information that is sent is filled with invalid values. The change time of the signal cycle status can be acquired from the infrastructure data. The driving support device can determine the several minutes before and after the predetermined time as a time zone during which the sending of signal cycle information is stopped.

(Increase/Decrease in Number of Lanes and Change in Traveling Direction of Driving Lane)

The “increase/decrease in number of lanes and change in traveling direction of driving lane” scene refers to a scene in which the centerline of the traveling road or the traveling direction of the driving lane is changed. At this change time and in a predetermined time zone several minutes before and after the change time, the signal cycle information is not sent from the roadside transmitter or the signal cycle information that is sent is filled with invalid values. The road line-shape switching time at which these changes are made can be acquired from the infrastructure data.

(FAST, PTPS, M-MOCS Operation Time)

The “FAST, PTPS, M-MOCS operation time” scene refers to a scene in which the traffic lights at the intersections ahead of the traveling direction are controlled during the operation of FAST, PTPS, or M-MOCS, as described with reference to FIG. 4. Whether FAST, PTPS, or M-MOCS is in operation can be acquired from the infrastructure data.

(Periodic Inspection, Sudden Inspection, or Manual Control by Police Officer)

The “periodic inspection, sudden inspection, or manual control by police officer” scene refers to a scene in which the automatic operation of a traffic light is stopped when the periodic inspection or sudden inspection of the traffic light is performed or when the traffic light is manually controlled by a police officer. The information that the traffic light is under inspection or under manual control can be acquired from the infrastructure data.

FIG. 8 is a diagram showing an example of the settings of the scene determination condition, selectable solution, and providable service for each of the signal cycle information non-acquisition scenes which are assumed in this embodiment and in which signal cycle information is not received. As shown in FIG. 8, the following five scenes are set as a scene in which signal cycle information is not received: “radio wave barrier”, “radio wave interference”, “electric system noise”, “increased ECU processing load”, and “part or apparatus failure”.

The “radio wave barrier” scene includes a poor visibility situation that arises when there is a large-sized vehicle (truck, bus) between the vehicle 2 and the infrastructure or a poor visibility situation that arises between the vehicle 2 and the roadside infrastructure due to the road structure (grade separation, curve, slope, etc.) or the road construction (pedestrian bridge, sign, etc.).

The “radio wave interference” scene includes a situation in which interference is caused by a disturbing radio wave (same frequency), a situation in which the time shared control of road-vehicle communication or vehicle-vehicle communication is not performed properly and, as a result, interference is caused (hidden terminal state of vehicle-vehicle communication unit), and an effect of the higher harmonic wave of a high output power wireless unit.

The “electric system noise” scene includes noises generated at the differential operation time of insufficient noise-protection components, such as a wiper and a blower installed on the host vehicle or such as a compressor or an ignition noise installed on other vehicles, or noises generated by an environmental factor such as a location near a factory or a railroad.

The “increased ECU processing load” scene includes situations, such as those described with reference to FIG. 5, in which the reception processing of infrastructure data is delayed or cannot be performed because of the following reasons: the processing load of the HMI processing is increased when the driving support service is provided based on signal cycle information or the ECU processing load is increased when other services such as the vehicle-vehicle communication service are provided.

The “part or apparatus failure” scene includes a situation in which a contact failure, a disconnection, or a failure is generated in the radio antenna, antenna cable, or reception circuit.

When signal cycle information is not available, the signal cycle estimation unit 53 determines to which of the above-described plurality of signal cycle information non-acquisition scenes the current state corresponds, based on the acquired infrastructure data. More specifically, the signal cycle estimation unit 53 selects a scene, which satisfies the “scene determination condition” that is set for each of the scenes in FIGS. 6 and 8, as the current scene. As exemplified in FIGS. 6 and 8, the “scene determination condition” selectively includes the two items: one is a “situation” item that indicates the current data reception state and the other is a “means” item that indicates the information used for determining a scene. When all items of a scene are satisfied, it is determined that the “scene determination condition” that is set for the scene is satisfied.

For each of the items of the “scene determination condition” in FIG. 6 for the scenes in which signal cycle information is not sent, specific content may be set for each of the items as shown in FIG. 7. For each of the items of the “scene determination condition” in FIG. 8 for the scenes in which signal cycle information is not received, specific content may be set for each of the items as shown in FIG. 9.

After determining the current scene, the signal cycle estimation unit 53 can select a solution from the solutions, which are set in the “selectable solution” item for each scene in FIGS. 6 and 8, and execute the selected solution to estimate the signal cycle information. When a plurality of solutions is set for the scene, the signal cycle estimation unit 53 selects and uses one solution based on the priority and the usability condition that are set for each solution.

With reference to FIGS. 6, 11, and 12, the following describes the selection of a solution using scene No. 1 “three-color traffic light⇄blink traffic light” as an example.

Referring to the “selectable solution” item in FIG. 6, priority 1 is assigned to solutions 1-1 and 1-2, priority 2 is assigned to solution 1-4, and priority 3 is assigned to solution 1-3. In addition, the following time conditions are assigned: “three-color signal time zone” is assigned to solution 1-1, “blink signal time zone” is assigned to solution 1-2, “until time immediately before switching” is assigned to solution 1-4, and “any time zone” is assigned to solution 1-3.

Now, consider a switching time from three-color lighting to blink lighting with reference to FIG. 11. Solutions 1-1 and 1-4 are limited to the time before the control start time. Solution 1-2 is limited to the time after the control start time. Solution 1-3 may be selected in any time zone before and after the control start time. That is, at a switching time from three-color lighting to blink lighting, solutions 1-1, 1-4, and 1-3 are selected in this priority order before the control start time; on the other hand, solutions 1-2 and 1-3 are selected in this priority order after the control start time.

Next, consider a switching time from blink lighting to three-color lighting with reference to FIG. 12. Solutions 1-1, 1-2, and 1-4 are limited to the time before the control end time. Solution 1-3 may be selected in any time zone before and after the control end time. That is, at a switching time from blink lighting to three-color lighting, solutions 1-1, 1-2, 1-4, and 1-3 are selected in this priority order before the control end time, and solution 1-3 after the control end time.

After a solution is selected, the signal cycle estimation unit 53 extracts the type of providable driving support service(s) associated with the solution, as shown in the item “providable service” in FIGS. 6 and 8, and sends the extracted service(s), as well as the estimated signal cycle information, to the driving support operation unit 54. The driving support operation unit 54, HMI control unit 55, and HMI device 4 use the signal cycle information, estimated by the signal cycle estimation unit 53, to provide providable driving support service(s) to the driver.

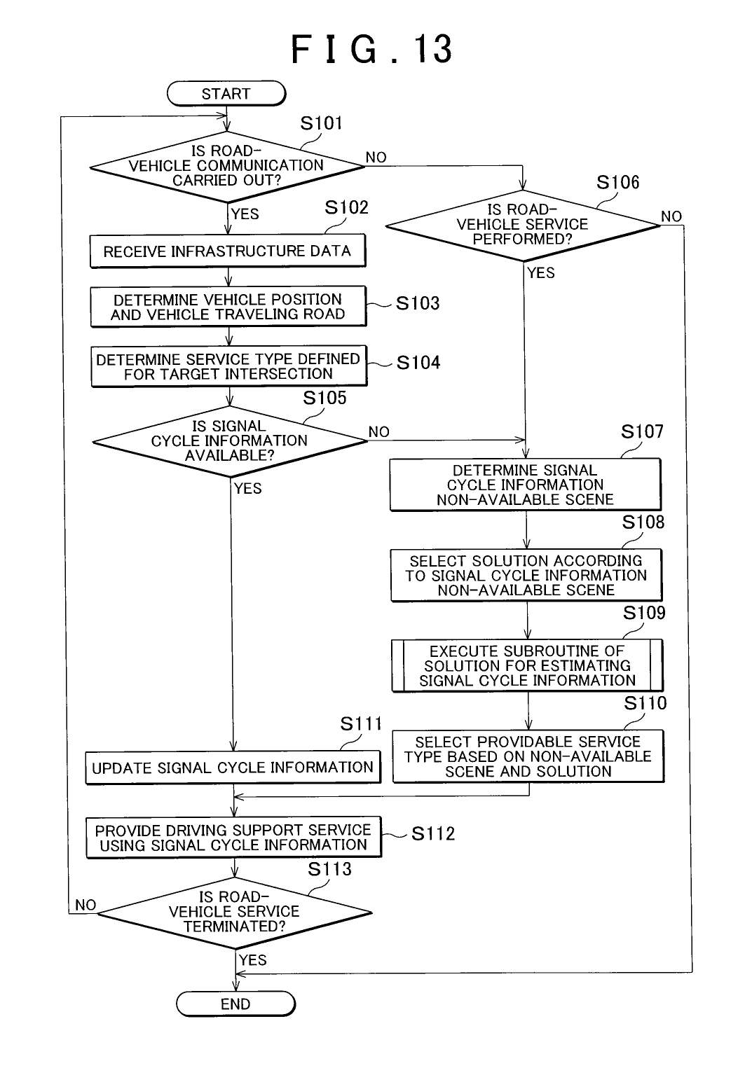

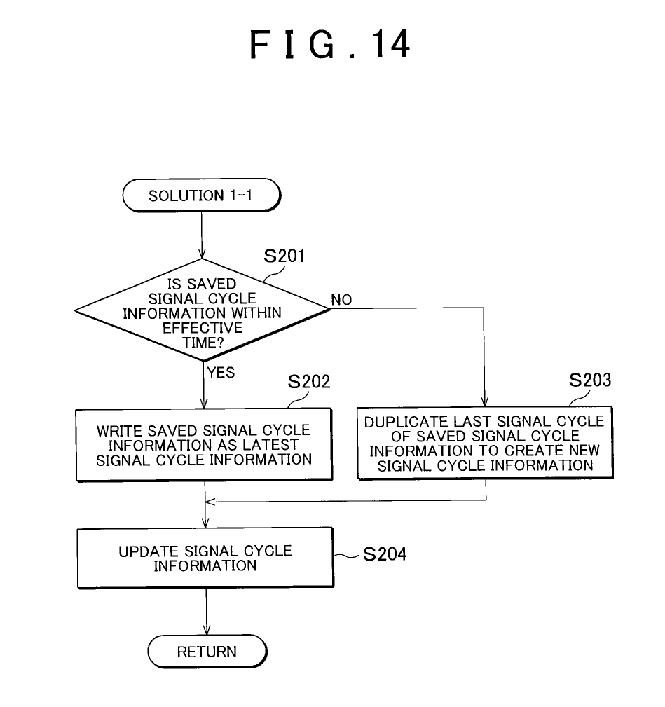

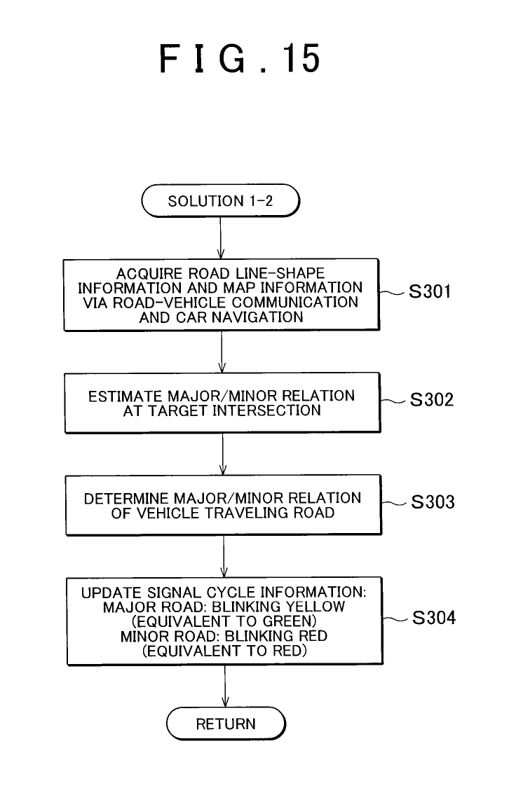

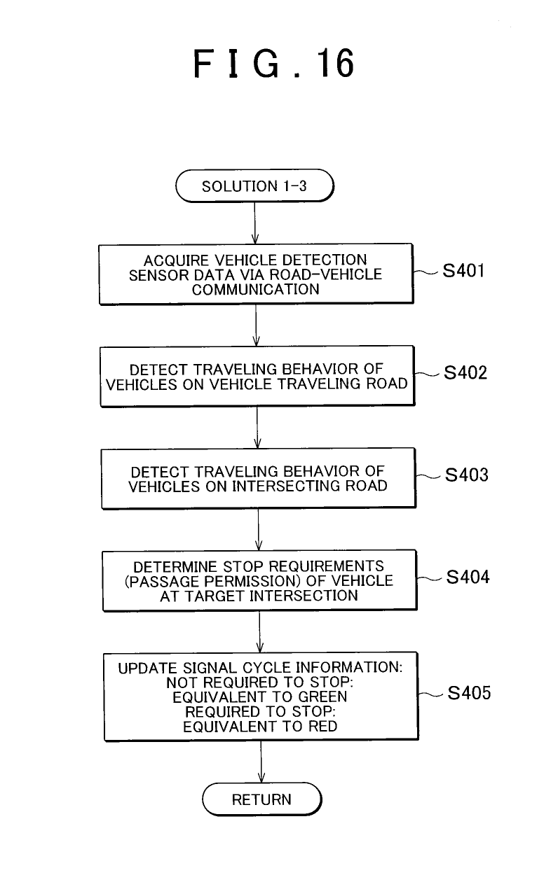

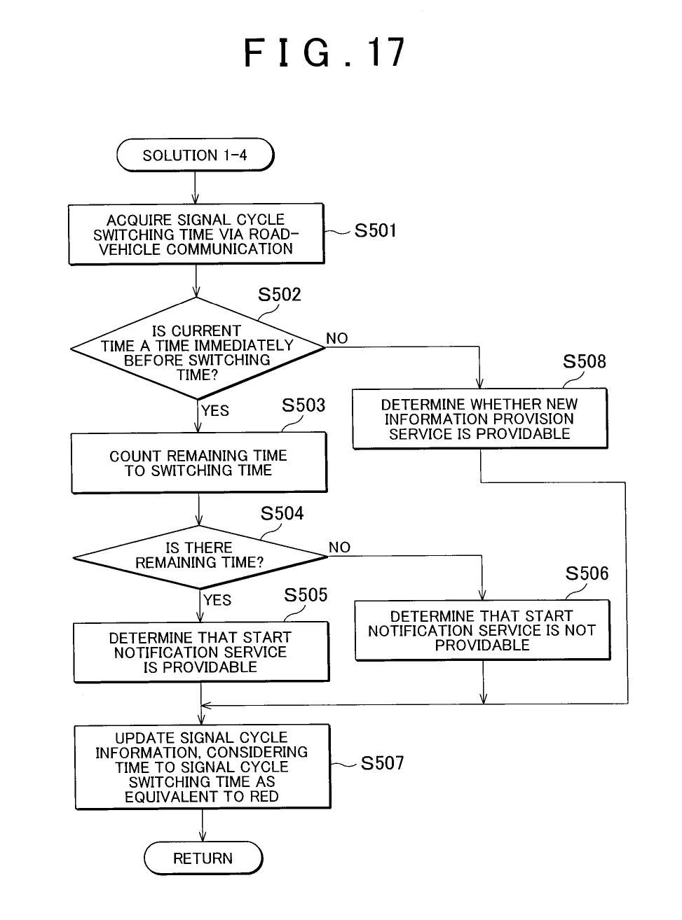

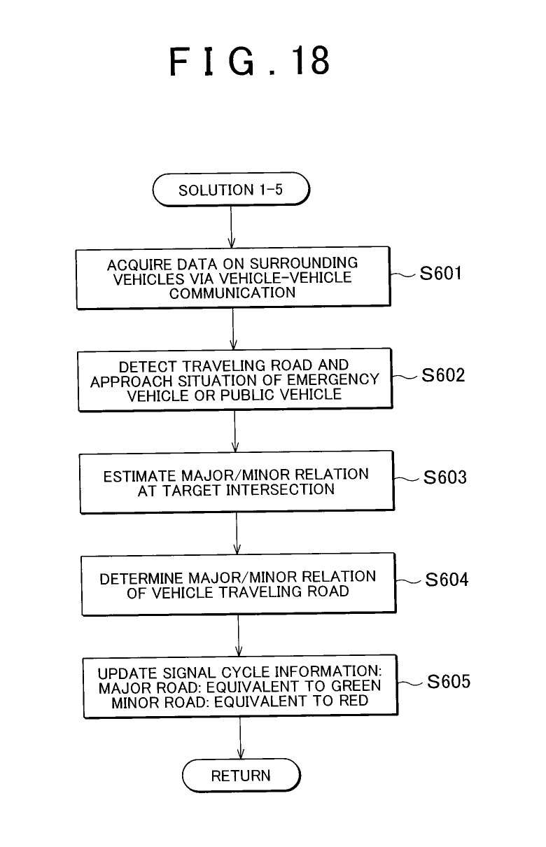

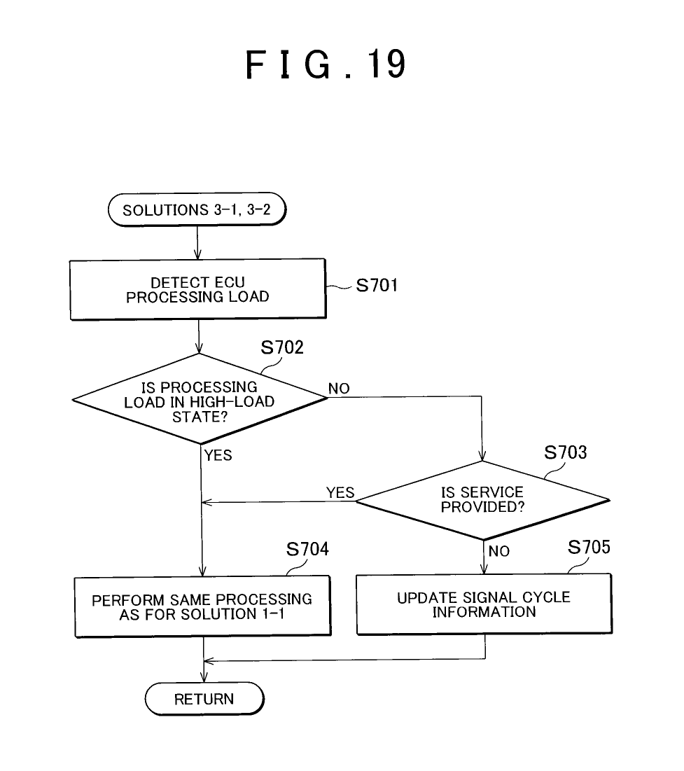

Next, the operation of the driving support device 1 in this embodiment is described with reference to FIGS. 13-19. FIG. 13 is a main flow showing the driving support processing performed by the driving support device in this embodiment, FIG. 14 shows a subroutine showing the processing of solution 1-1 performed by the driving support operation unit, FIG. 15 shows a subroutine showing the processing of solution 1-2 performed by the driving support operation unit, FIG. 16 shows a subroutine showing the processing of solution 1-3 performed by the driving support operation unit, FIG. 17 shows a subroutine showing the processing of solution 1-4 performed by the driving support operation unit, FIG. 18 shows a subroutine showing the processing of solution 1-5 performed by the driving support operation unit, and FIG. 19 shows a subroutine showing the processing of solutions 3-1 and 3-2 performed by the driving support operation unit.

As shown in the main flow in FIG. 13, the communication control unit 51 first confirms if road-vehicle communication is carried out (S101). The communication control unit 51 can confirm if road-vehicle communication is carried out, for example, by checking the operation state of the road-vehicle communication unit 60.

If it is determined that road-vehicle communication is carried out (Yes in S101), the communication control unit 51 receives infrastructure data on the surrounding of the vehicle 2 (S102). The communication control unit 51 receives various types of information on infrastructure data from various devices such as the road-vehicle communication unit 60, vehicle-vehicle communication unit 61, GPS-ECU 62, map database 63, and car navigation device 64. The received infrastructure data is sent to the reception data processing unit 52.

The reception data processing unit 52 determines the vehicle position and the vehicle traveling road (S103). The reception data processing unit 52 calculates the vehicle position, such as the latitude/longitude information on the vehicle 2, based on the information acquired from the GPS-ECU 62, and determines the road, on which the vehicle 2 is traveling, based on the calculated vehicle position and the road information obtained from the map database 63 or the car navigation device 64. The reception data processing unit 52 sends the infrastructure data, which includes the determined information on the vehicle position and on the vehicle traveling road, to the driving support operation unit 54.

When the intersection ahead on the vehicle traveling road is identified as a target intersection based on the infrastructure data received from the reception data processing unit 52, the driving support operation unit 54 determines the service type defined for the target intersection (S104).

At this point in time, the driving support operation unit 54 confirms if signal cycle information can be acquired (S105). More specifically, the driving support operation unit 54 confirms if the infrastructure data, received from the reception data processing unit 52, includes signal cycle information. If it is determined that signal cycle information is not available (No in S105), the situation is that the infrastructure data is received but signal cycle information is not included in the received infrastructure data. Therefore, the processing proceeds to step S107 assuming that a failure is generated on the signal cycle information sending side (roadside communication unit).

If it is determined that signal cycle information can be acquired (Yes in S105), the signal cycle information is updated using the signal cycle information included in the newly acquired infrastructure data (S111). The driving support operation unit 54, HMI control unit 55, and HMI device 4 provide the driving support service using the updated signal cycle information (S112).

On the other hand, if it is determined in step S101 that road-vehicle communication is not carried out (No in S101), a confirmation is made next if the road-vehicle service is performed (S106). If it is determined that the road-vehicle service is performed (Yes in S106), the situation is that the road-vehicle service is performed but road-vehicle communication is not carried out. Therefore, the processing proceeds to step S107 assuming that the infrastructure data (signal cycle information) cannot be received due to a failure in the reception status on the signal cycle information receiving side (vehicle 2). If it is determined that the road-vehicle service is not performed (No in S106), the situation is that road-vehicle communication is not carried out nor is the road-vehicle service performed. In this case, the processing is terminated without performing the driving support service.

If it is determined in step S105 that signal cycle information is not available (No in S105) or if it is determined in step S106 that the road-vehicle service is performed (Yes in S106), the situation is that signal cycle information is not available. Therefore, the signal cycle estimation unit 53 performs the signal cycle estimation processing in step S107 and the subsequent steps.

First, the signal cycle estimation unit 53 determines a signal cycle information non-acquisition scene (S107). Using various types of information included in the infrastructure data acquired by the communication control unit 51, the signal cycle estimation unit 53 checks the situation against a determination condition, which is listed in the “scene determination condition” item in FIGS. 6 and 8 and is set for each scene, and determines a scene, which satisfies all conditions, as the signal cycle information non-acquisition scene at the current time.

Next, the signal cycle estimation unit 53 selects a solution for estimating the signal cycle information according to the signal cycle information non-acquisition scene determined in step S107 (S108). The signal cycle estimation unit 53 can select a solution, assigned to the scene selected in step S107, as exemplified in the “selectable solution” item in FIGS. 6 and 8. If there is a plurality of solutions assigned to the scene, the signal cycle estimation unit 53 selects one solution considering the time condition or the priority specified individually for each solution.

The subroutine for the solution selected in step S108 is executed for estimating the signal cycle information (S109). The subroutine for each solution will be described later with reference to FIGS. 14-19.

Based on the signal cycle information non-acquisition scene determined in step S107 and on the solution selected in step S108, an provable service type, associated with the signal cycle information non-acquisition scene and the solution, is selected with reference to FIGS. 6 and 8 (S110).

The driving support operation unit 54, HMI control unit 55, and HMI device 4 use the signal cycle information, estimated in step S109, to provide the driving support service selected in step S110 (S112).

In addition, a check is made whether the road-vehicle service is terminated (S113). If the road-vehicle service is continued (No in S113), the processing returns to step S101 to repeat the flow for continued driving support based on signal cycle information. If the road-vehicle service is terminated (Yes in S113), the processing is terminated.

Next, the subroutines for the solutions, executed in step S109 in the main flow in FIG. 13, are described individually with reference to FIGS. 14-19.

First, the subroutine of solution 1-1 is described with reference to FIG. 14.

A check is made if the signal cycle information saved in the driving support device 1 is within the effective time (S201). The saved signal cycle information, if within the effective time (Yes in S201), is written as the latest signal cycle information (S202). On the other hand, if the saved signal cycle information is not within the effective time (No in S201), the last signal cycle of the saved signal cycle information is duplicated to create new signal cycle information (S203).

After that, the signal cycle information is updated (S204) using the signal cycle information created in step S202 or S203, and the processing returns to the main flow.

Next, the subroutine of solution 1-2 is described with reference to FIG. 15.

The road-vehicle communication unit 60 and the car navigation device 64 acquire the road line-shape information and the map information (S301). Based on the road line-shape information and the map information acquired in step S301, the major/minor relation at the target intersection is estimated (S302). That is, the subroutine estimates whether each of the roads entering the target intersection is a major road or a minor road.

Based on the major/minor relation at the intersection estimated in step S302, it is determined whether the road, on which the vehicle 2 is traveling, is a major road or a minor road (S303).

The signal cycle information is updated (S304) according to the major/minor relation of the traveling road determined in step S303, and the processing returns to the main flow. More specifically, if the road, on which the host vehicle is traveling, is a major road, the signal cycle information is updated with blinking yellow light (equivalent to green light). If the road, on which the host vehicle is traveling, is a minor road, the signal cycle information is updated with blinking red light (equivalent to red light).

Next, the subroutine of solution 1-3 is described with reference to FIG. 16.

The road-vehicle communication unit 60 acquires the vehicle detection sensor data at the target intersection (S401). That is, the information on whether vehicles are present on the roads entering the target intersection is acquired.

The traveling behavior of the other vehicles (vehicles ahead or oncoming vehicles) on the road, on which the vehicle 2 is traveling, is detected (S402) using the vehicle detection sensor data acquired in step S401. In addition, the traveling behavior of the other vehicles on the road, which intersects with the host-vehicle traveling road at the intersection, is detected (S403).

Based on the traveling behavior of the other vehicles on the host-vehicle traveling road and on the intersecting road detected respectively in steps S402 and S403, the entering status of the other vehicles into the target intersection is estimated, and the stop requirements (passage permission) of the vehicle 2 at the target intersection is determined (S404).

After that, the signal cycle signal is updated (S405) according to the stop requirements determined in step S404, and the processing returns to the main flow. More specifically, if the vehicle is not required to stop, the signal cycle information is updated to information equivalent to green light. On other hand, if the vehicle is required to stop, the signal cycle information is updated to information equivalent to red light.

Next, the subroutine of solution 1-4 is described with reference to FIG. 17.

The signal cycle switching time is acquired by the road-vehicle communication unit 60 (S501), and a check is made if the current time is included in a predetermined range immediately before the switching time (S502). If the current time is determined as a time immediately before the switching time (Yes in S502), the remaining time to the switching time is counted (S503) to check if the remaining time to the switching is equal to or larger than a predetermined value (S504).

If the remaining time is equal to or larger than the predetermined value (Yes in S504), it is determined that the start notification service (service C) is providable (S505). If the remaining time is smaller than the predetermined value (No in S504), it is determined that the start notification service (service C) is not providable (S506). After that, using the remaining time calculated in step S503, the signal cycle information is updated considering the remaining time to the status switching time, that is, the time from the current time to the signal cycle switching time, as equivalent to red light (S507). After that, the processing returns to the main flow.

If it is determined in step S502 that the current time is not a time immediately before the switching time (No in S502), it is also possible to determine whether a new information provision service other than services A, B, and C is providable (S508).

Next, the subroutine of solution 1-5 is described with reference to FIG. 18.

Data on the surrounding vehicles is acquired by the vehicle-vehicle communication unit 61 (S601) and, based on this vehicle data, the traveling road and approach situation of an emergency vehicle (such as an ambulance) or a public vehicle (such as a bus), included in the surrounding vehicles, are detected (S602).

The major/minor relation of the roads at a target intersection is estimated (S603) according to the traveling state of the surrounding emergency vehicle or public vehicle detected in step S602. More specifically, as described with reference to FIG. 4, the traveling road of an emergency vehicle or a public vehicle is a major road, and the other roads are minor road.

The major/minor relation of the traveling road of the vehicle 2 is determined (S604) according to the major/minor relation of the target intersection estimated in step S603. That is, when the vehicle 2 is traveling on the same road as that of the emergency vehicle or public vehicle, the road is determined as a major road. When the vehicle 2 is traveling on other roads, the road is determined as a minor road.

After that, the signal cycle information is updated (S605) according to the major/minor relation of the traveling road of the vehicle 2 determined in step S604, and the processing returns to the main flow. More specifically, if the traveling road of the vehicle 2 is a major road, the signal cycle information is updated to information equivalent green light; if the traveling road is a minor road, the signal cycle information is updated to information equivalent to red light.

Next, the subroutine processing of solutions 3-1 and 3-2 is described with reference to FIG. 19.

First, the ECU processing load of the vehicle 2 is detected (S701) to check if the processing load is in the high-load state (S702). If the ECU processing load is in the high-load state (Yes in S702), the same processing as that for solution 1-1 is performed (S704) and the processing returns to the main flow. That is, if the ECU processing load is high, the infrastructure data reception processing for acquiring new signal cycle information is not performed and the signal cycle information is updated using the acquired signal cycle information.

On the other hand, if the ECU processing load is in the low-load state (No in S702), a check is made next if a service for driving support is currently provided (S703). If a service is provided (Yes in S703), the same processing as that for solution 1-1 is performed as in the high-load state (S704).

If a service is not provided (No in S703), the signal cycle information is updated as usual (S705). That is, the processing is performed by the road-vehicle communication unit 60 to receive new infrastructure data, and new signal cycle information is acquired from the infrastructure data for use in updating.

Next, the effect of the driving support device in this embodiment is described.

The driving support device 1 in this embodiment performs the driving support of the vehicle 2 based on the signal cycle information on the lighting color cycle of the traffic light at the intersection 71. When the signal cycle information is not available, the driving support device 1 estimates the signal cycle information based on the infrastructure data that is the information on the surrounding of the intersection 71 and, based on the estimated signal cycle information, performs driving support.

The driving support service, providable by the driving support device 1 and based on the signal cycle information, includes various services such as services A, B, and C described above. If signal cycle information is not available for some reason or other, none of these services can be provided. If signal cycle information is not available, this embodiment with the configuration described above estimates the signal cycle information based on the infrastructure data. Therefore, this embodiment can continuously provide the driving support service based on the signal cycle information with no interruption, thus allowing driving support to be performed suitably even if signal cycle information is not available.

In addition, the driving support device 1 in this embodiment provides a plurality of solutions for estimating signal cycle information and selects a solution, used for estimating signal cycle information, from the plurality of solutions according to a scene in which signal cycle information is not available.

This configuration makes it possible to estimate signal cycle information appropriately according to a scene, in which signal cycle information is not available, and to estimate signal cycle information accurately, enabling driving support to be performed still more suitably even if signal cycle information is not available.

In addition, the driving support device 1 in this embodiment selects a providable service from the services for driving support according to a selected solution and a scene in which signal cycle information is not available.

This configuration allows driving support to be performed only for a providable service according to a scene in which signal cycle information is not available, enabling driving support to be performed still more suitably even when signal cycle information is not available.

The case in which “signal cycle information is not available” to the driving support device 1 in this embodiment refers to a case in which the signal cycle information sending side fails to send signal cycle information. Even if such a condition occurs and a roadside infrastructure, such as the roadside communication unit 60a, cannot send signal cycle information, the driving support device 1 can continuously provide the driving support service based on the signal cycle information with no interruption.

The case in which “signal cycle information is not available” to the driving support device 1 in this embodiment refers to a case in which the signal cycle information receiving side fails to receive signal cycle information. Even if such a condition occurs and some communication failure occurs between the sending side and the receiving side of signal cycle information, the driving support device 1 can continuously provide the driving support service based on the signal cycle information with no interruption.

The case in which “signal cycle information is not available” to the driving support device 1 in this embodiment refers to a case in which the information processing load in the vehicle 2 is high and the reception processing of signal cycle information is delayed. Even if such a condition is present when signal cycle information is received and, as a result, the processing is delayed, the driving support device 1 can continuously provide the driving support service based on the signal cycle information with no interruption.

In addition, the driving support device 1 in this embodiment determines whether the traveling road of the vehicle 2 is a major road or a minor road based on the road information at the intersection 71. As a result, if the road is a major road, the driving support device 1 estimates the signal cycle information as equivalent to green light; if the road is a minor road, the driving support device 1 estimates the signal cycle information as equivalent to red light. This allows signal cycle information to be estimated based on the road information on the intersection 71 when the signal cycle information is not available, making it possible to continuously provide the driving support service based on the signal cycle information with no interruption.

In addition, the driving support device 1 in this embodiment determines whether the vehicle 2 is required to stop at the intersection 71 based on the presence of other vehicles or pedestrians around the intersection 71. As a result, if the vehicle 2 is not required to stop, the driving support device 1 estimates the signal cycle information as equivalent to green light; if the vehicle 2 is required to stop, the driving support device 1 estimates the signal cycle information as equivalent to red light. This allows signal cycle information to be estimated based on the presence of other vehicles or pedestrians around the intersection 71 when the signal cycle information is not available, making it possible to continuously provide the driving support service based on the signal cycle information with no interruption.

In addition, the driving support device 1 in this embodiment estimates signal cycle information based on the remaining time to the signal type switching time at the intersection 71. This allows signal cycle information to be estimated based on the remaining time to the signal type switching time at the intersection 71 when the signal cycle information is not available, making it possible to continuously provide the driving support service based on the signal cycle information with no interruption.

In addition, the driving support device 1 in this embodiment estimates signal cycle information based on acquired signal cycle information. This allows signal cycle information to be estimated based on the acquired signal cycle information when the signal cycle information is not available, making it possible to continuously provide the driving support service based on the signal cycle information with no interruption.

In addition, the driving support device 1 in this embodiment determines whether the traveling road of the vehicle 2 is a major road or a minor road based on the presence of an emergency vehicle or a public vehicle around the intersection 71. As a result, if the road is a major road, the driving support device 1 estimates the signal cycle information as equivalent to green light; if the road is a minor road, the driving support device 1 estimates the signal cycle information as equivalent to red light. This allows signal cycle information to be estimated based on the presence of an emergency vehicle or a public vehicle around the intersection 71 when the signal cycle information is not available, making it possible to continuously provide the driving support service based on the signal cycle information with no interruption.

[Modification]

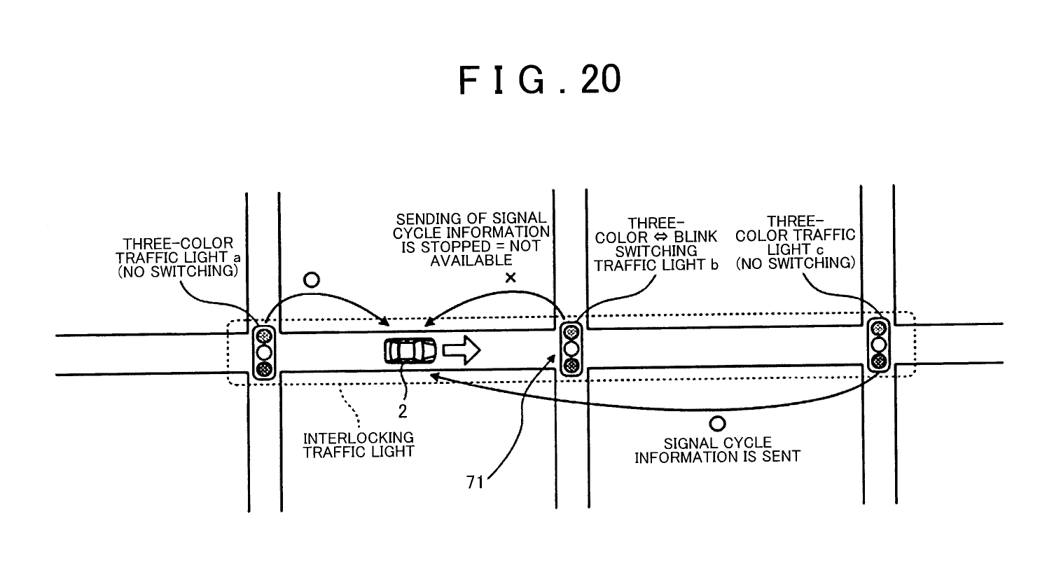

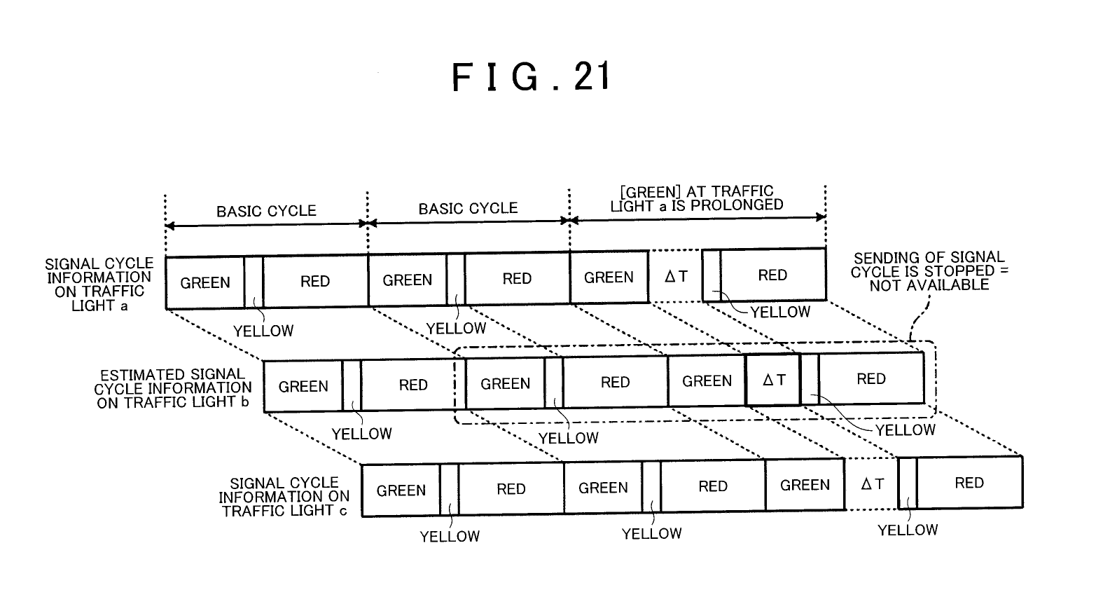

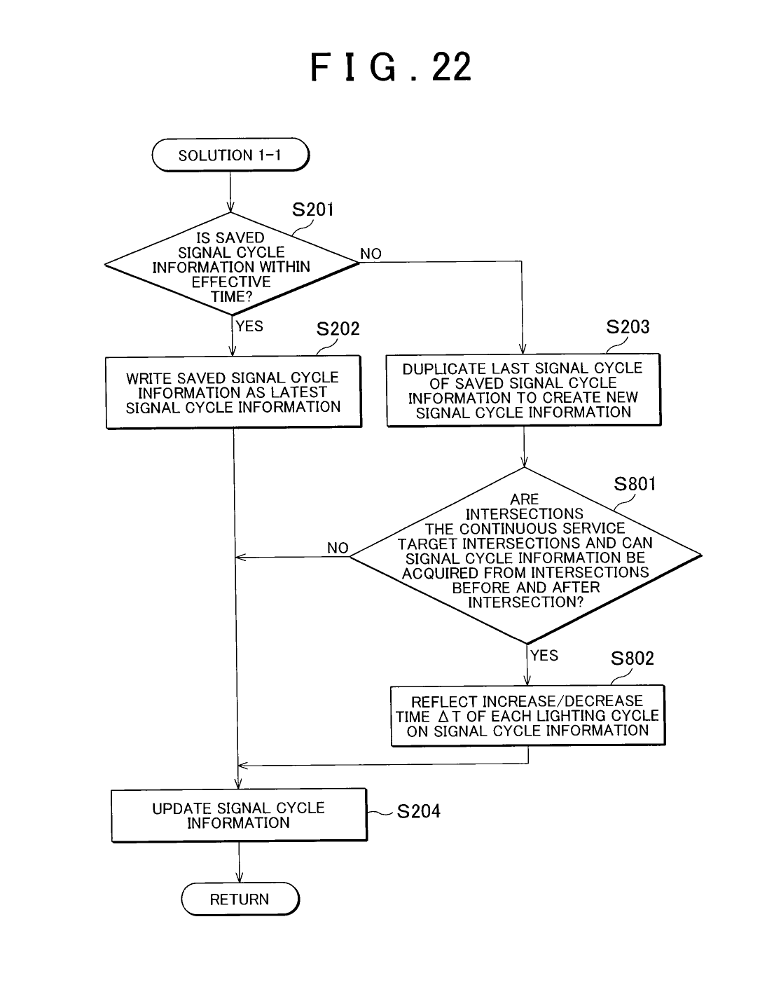

Next, a modification of the embodiment is described with reference to FIGS. 20-22. FIG. 20 is a schematic diagram showing an example of a configuration of road-vehicle communication in the modification of this embodiment, FIG. 21 is a schematic diagram showing a signal cycle information estimation method used in the modification of this embodiment, and FIG. 22 shows a subroutine showing the processing of solution 1-1 performed by the modification of this embodiment.

In this modification, the processing content of solution 1-1, one of the plurality of solutions provided by the signal cycle estimation unit 53 of the above-described embodiment for estimating signal cycle information, is partially modified.

Consider a case in which interlocking traffic lights are installed before and after the service target intersection 71 when signal cycle information on the intersection 71 is not sent from the roadside communication unit 60a. Interlocking traffic lights refer to a plurality of traffic lights the signal cycles of which are interlocked. For example, as shown in FIGS. 20 and 21, the signal cycles of a plurality of traffic lights, sequentially arranged on a road, are set to the same cycle (or the time required for one cycle is set equal among them). This plurality of traffic lights is configured for the management of smooth operation of passing vehicles, for example, to allow a vehicle traveling at a predetermined speed to pass through a series of traffic lights all on the green light. In addition, the lighting time for green or red light of the interlocking traffic lights can be varied flexibly according to the amount of passing vehicles.

In solution 1-1 in the embodiment described above, when signal cycle information is not available from the service target intersection 71, the already acquired signal cycle information is used to estimate new signal cycle information. In contrast, in this modification, the signal cycle information on the interlocking traffic lights before and after the service target intersection 71 (traffic lights a and c in FIG. 20) is also used to estimate the signal cycle information on the traffic light at the service target intersection 71 (traffic light b in FIG. 20).

More specifically, when the signal cycle of an interlocking traffic light before or after the service target intersection 71 is changed as shown in FIG. 21, the changed lighting color and its increase/decrease time (ΔT) are confirmed. After that, ΔT is reflected also on the same lighting color of the signal cycle information on the service target intersection 71. In the example shown in FIG. 21, the time for the green lighting color of traffic light a is increased by ΔT and, accordingly, the time for the green lighting color in the second cycle is increased by ΔT also in estimating the signal cycle information on the service target intersection 71.

In this modification, the subroutine of solution 1-1 is configured as shown in FIG. 22 by adding steps S801 and S802 to the subroutine of solution 1-1 of the embodiment described with reference to FIG. 14. The following describes only a part of the subroutine in FIG. 22 that is changed from the subroutine shown in FIG. 14.

After new signal cycle information is created in step S203, a check is made if the service target intersection 71 and the intersections before and after the service target intersection 71 are continuous service target intersections each with an interlocking traffic light and if signal cycle information can be acquired from the intersections before and after the service target intersection 71 (S801). If the condition in step S801 is not satisfied, the processing proceeds to step S204 to update the signal cycle information using the signal cycle information created in step S203.

On the other hand, if the condition in step S801 is satisfied, a check is made if the basic cycle of signal cycle information on the intersections before and after the service target intersection 71 is changed. If the basic cycle is changed, the increase/decrease time ΔT of each lighting cycle is reflected on the signal cycle information created in step 203 (S802). After that, the processing proceeds to step S204 to update the signal cycle information using the signal cycle information created in step S802.

While preferred embodiments of the present invention have been described above, the present invention is not limited to these embodiments. The components of the embodiments of the present invention can be changed to those that are replaceable easily by those skilled in the art or to those that are substantially the same.

### REFERENCE SIGNS LIST

1 Driving support device
2 Vehicle
4 HMI device
5 Controller
53 Signal cycle estimation unit
71 Service target intersection

1-12. (canceled)

13. A driving support device comprising a control device and a support device that perform driving support of a host vehicle based on signal cycle information on a lighting cycle of a traffic light at an intersection, wherein:
when the signal cycle information is not available, the control device estimates the signal cycle information based on surrounding information on the intersection to perform driving support based on the estimated signal cycle information; and
the control device includes a plurality of estimation methods for estimating the signal cycle information and selects an estimation method, used for estimating the signal cycle information, from the plurality of estimation methods according to a scene in which the signal cycle information is not available.

14. The driving support device according to claim 13, wherein the control device selects a providable service from services for the driving support according to the selected estimation method and the scene.

15. The driving support device according to claim 13, wherein a case in which the signal cycle information is not available refers to a case in which a sending side of the signal cycle information fails to send the signal cycle information.

16. The driving support device according to claim 13, wherein a case in which the signal cycle information is not available refers to a case in which a receiving side of the signal cycle information fails to receive the signal cycle information.

17. The driving support device according to claim 13, wherein a case in which the signal cycle information is not available refers to a case in which an information-processing load in the host vehicle is high and a reception processing of the signal cycle information is delayed.

18. The driving support device according to claim 13, wherein the surrounding information includes at least one of road information on the intersection, a presence state of other vehicles or pedestrians around the intersection, a remaining time to a signal type switching time at the intersection, acquired signal cycle information, and a presence state of an emergency vehicle or a public vehicle around the intersection.

19. The driving support device according to claim 13, wherein the control device determines whether a traveling road of the host vehicle is a major road or a minor road based on road information on the intersection, estimates the signal cycle information as equivalent to green light when it is determined that the traveling road is the major road, and estimates the signal cycle information as equivalent to red light when it is determined that the traveling road is the minor road.

20. The driving support device according to claim 13, wherein the control device determines whether the host vehicle is required to stop at the intersection based on a presence state of other vehicles or pedestrians around the intersection, estimates the signal cycle information as equivalent to green light when it is determined that the vehicle is not required to stop, and estimates the signal cycle information as equivalent to red light if it is determined that the vehicle is required to stop.

21. The driving support device according to claim 13, wherein the control device estimates the signal cycle information based on a remaining time to a signal type switching time at the intersection.

22. The driving support device according to claim 13, wherein the control device estimates the signal cycle information based on the acquired signal cycle information.

23. The driving support device according to claim 13, wherein the control device determines whether a traveling road of the host vehicle is a major road or a minor road based on a presence state of an emergency vehicle or a public vehicle around the intersection, estimates the signal cycle information as equivalent to green light when it is determined that the traveling road is the major road, and estimates the signal cycle information as equivalent to red light when it is determined that the traveling road is the minor road.
